(19) United States
(12) Patent Application Publication
(10) Pub. No.: US 2020/0042650 A1
(43) Pub. Date: Feb. 6, 2020

(54) METHODS OF RENDERING A MOBILE APPLICATION PAGE BASED ON PAST USAGE INFORMATION AND RELATED WIRELESS DEVICES

(71) Applicant: CA, Inc., New York, NY (US)

(72) Inventors: Subhasis Kumar KHATUA, Hyderabad (IN); Narendra DHULIPALLA, Madinaguda (IN); Manoj GUDALA, Saidabad (IN)

(73) Assignee: CA, Inc., New York, NY (US)

(21) Appl. No.: 16/055,539

(22) Filed: Aug. 6, 2018

(51) Int. Cl. G06F 17/30; H04L 29/08; G06F 17/18

(52) U.S. Cl. CPC G06F 17/30867; G06F 17/30905; G06F 17/18; H04L 67/04; G06F 17/30876

(57) ABSTRACT

Some embodiments disclosed herein are directed to methods of operating a wireless device. Past usage information relating to past usage of a mobile application on the wireless device may be provided. A page of the mobile application may be rendered on a display of the wireless device based on the past usage information relating to the past usage of the mobile application on the wireless device. The page may include a plurality of page elements, and rendering the page may include rendering a first subset of the plurality of page elements on the display based on the past usage information and omitting a second subset of the plurality of page elements based on the past usage information. Related wireless devices and computer program products are also discussed.

### TECHNICAL FIELD

The present disclosure relates to mobile applications running on wireless devices.

### BACKGROUND

A mobile application (also referred to as a mobile app or an app) is a computer program designed to run on a mobile wireless device such as a smartphone, a table computer, and/or a smartwatch. A mobile app may thus use a wireless mobile communication network carrier (e.g., a cellular radiotelephone network) as a data provider, and a speed of the mobile wireless communication network may vary (e.g., by location, time, shared network bandwidth, etc.) due to due to various factors (e.g., installed network capacity, current volume of data traffic, etc.). Moreover, the mobile wireless device running a mobile app may be constrained, for example, in terms of available battery power, display (screen) size, and/or processing capacity.

Accordingly, performance and/or functionality of a mobile app may vary depending on a current speed of the wireless mobile communication network, a currently available battery power, a display size, a processing capacity, etc. Such variations in performance and/or functionality may negatively impact a user experience with the mobile app.

### SUMMARY

Some embodiments disclosed herein are directed to methods of operating a wireless device. Past usage information relating to past usage of a mobile application on the wireless device may be provided. A page of the mobile application may be rendered on a display of the wireless device based on the past usage information relating to the past usage of the mobile application on the wireless device. The page may include a plurality of page elements, and rendering the page may include rendering a first subset of the plurality of page elements on the display based on the past usage information and omitting a second subset of the plurality of page elements based on the past usage information.

Some other related embodiments disclosed herein are directed to wireless devices. In such embodiments, a wireless device may include a transceiver, a processor, and memory. The transceiver may be configured to communicate over a wireless communication network with a remote server. The processor may be coupled with the transceiver, wherein the processor is configured to transmit and/or receive communications through the wireless communication network using the transceiver. The memory may be coupled with the processor, wherein the memory stores program instructions executable by the processor to perform the following operations. Past usage information relating to past usage of a mobile application on the wireless device may be provided. A page of the mobile application may be rendered on a display of the wireless device based on the past usage information relating to the past usage of the mobile application on the wireless device. The page may include a plurality of page elements, and rendering the page may include rendering a first subset of the plurality of page elements on the display based on the past usage information and omitting a second subset of the plurality of page elements based on the past usage information.

Some other related embodiments disclosed herein are directed to a computer program product. The computer program product may include a non-transitory computer readable storage medium comprising computer readable program code embodied in the medium that when executed by a processor of a wireless device causes the processor to perform the following operations. Past usage information relating to past usage of a mobile application on the wireless device may be provided. A page of the mobile application may be rendered on a display of the wireless device based on the past usage information relating to the past usage of the mobile application on the wireless device. The page may include a plurality of page elements, and rendering the page may include rendering a first subset of the plurality of page elements on the display based on the past usage information and omitting a second subset of the plurality of page elements based on the past usage information.

It is noted that aspects described with respect to one embodiment disclosed herein may be incorporated in different embodiments although not specifically described relative thereto. That is, all embodiments and/or features of any embodiments can be combined in any way and/or combination. Moreover, methods, wireless devices, and/or computer program products according to embodiments will be or become apparent to one with skill in the art upon review of the following drawings and detailed description. It is intended that all such additional methods, wireless devices, and/or computer program products be included within this description and protected by the accompanying claims.

### BRIEF DESCRIPTION OF THE DRAWINGS

Aspects of the present disclosure are illustrated by way of example and are not limited by the accompanying drawings. In the drawings:

FIG. 1 is a block diagram illustrating communication between a wireless device and a remote server through a wireless network base station and a local/wide area network according to some embodiments of inventive concepts;

FIG. 2 is a block diagram illustrating elements of a wireless device according to some embodiments of inventive concepts; and

FIG. 3 is a flow chart illustrating operations of a wireless device according to some embodiments of inventive concepts.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment. Like numbers refer to like elements throughout.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

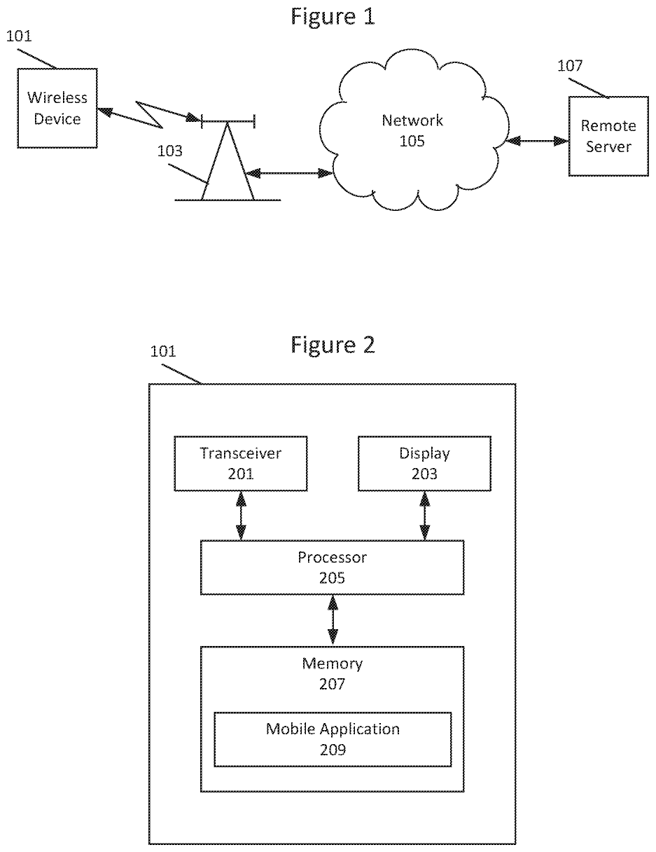

As shown in FIGS. 1 and 2, a mobile wireless device 101 (e.g., a smartphone, a tablet computer, a smartwatch, etc.) may have a mobile application 209 installed/stored in memory 207, and mobile application 209 may include instructions that when executed by processor 205 cause wireless device 101 to provide functionality of the mobile application. As part of such execution, processor 201 may transmit requests to remote server 107 (through transceiver 201) for elements of a page to be rendered on display 203, and responsive to such requests, remote server 107 may transmit data for such page elements. Accordingly, processor 205 may receive data for the requested page elements through transceiver 201, and processor 205 may use the received data to render the page (using the data for the page elements) on display 203. More particularly, wireless device 101 may transmit the requests through transceiver 201, wireless base station 103 (e.g., a base station of a cellular data network, a WiFi base station, etc.), and network 105 (e.g., a wide area network such as the Internet, a local area network, etc.), and remote server 107 may transmit the data through network 105 and base station 103 for reception by processor 205 through transceiver 201.

FIG. 2 is a block diagram illustrating elements of a wireless device 101 (e.g., a smartphone, a tablet computer, a smartwatch, etc.) configured to provide wireless communication according to embodiments of inventive concepts. As shown, wireless device 101 may include a transceiver circuit 201 (also referred to as a transceiver) including a transmitter and a receiver configured to provide uplink and downlink radio communications with a base station 103 of a radio access network. Wireless device 101 may also include a processor circuit 205 (also referred to as a processor) coupled to the transceiver circuit, and a memory circuit 207 (also referred to as memory) coupled to the processor circuit. The memory circuit 207 may include computer readable program code (including mobile application 209) that when executed by the processor circuit 205 causes the processor circuit to perform operations according to embodiments disclosed herein. According to other embodiments, processor circuit 205 may be defined to include memory so that a separate memory circuit is not required. Wireless device 101 may also include display 203 coupled with processor 205 to provide visual output, and display 203 may be touch sensitive to also accept user input. Wireless device may include additional user interface elements (e.g., a speaker, a microphone, one or more physical buttons, etc.) coupled with processor 205 to accept user input and/or provide user output.

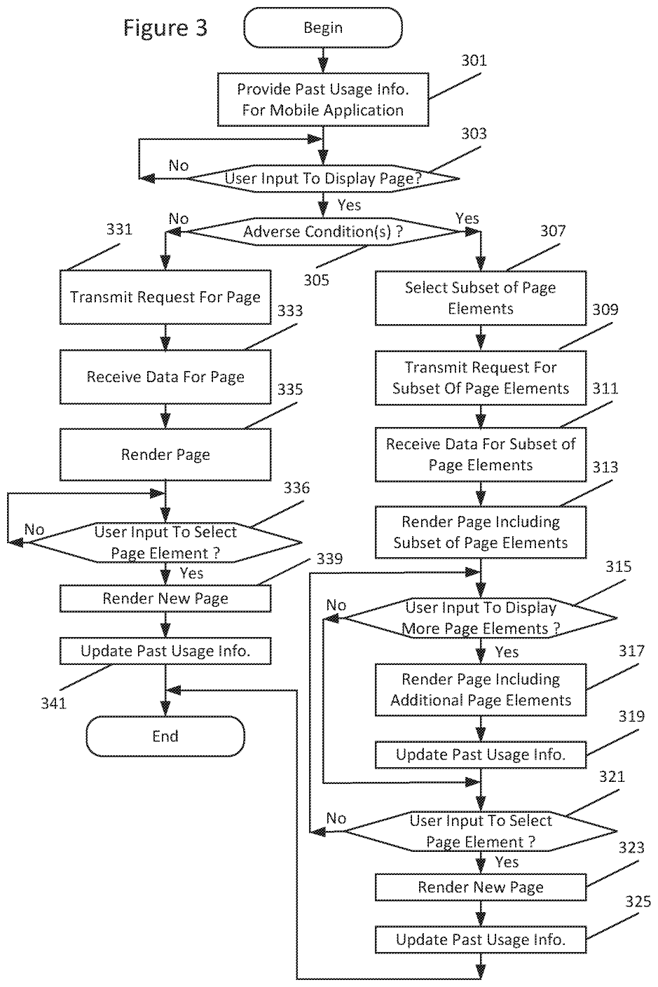

As discussed herein, operations of wireless device 101 may be performed by processor 205, display 203, and/or transceiver 201. For example, processor 205 may control transceiver 201 to transmit communications through transceiver 201 over a radio interface to a base station 103 and/or to receive communications through transceiver 201 from base station 103 over a radio interface. Moreover, modules (including modules of mobile application 209) may be stored in memory 207, and these modules may provide instructions so that when instructions of a module are executed by processor 205, processor 205 performs respective operations (e.g., operations discussed below with respect to the flow chart of FIG. 3).

According to some embodiments of inventive concepts, a user experience with mobile application 209 operating on wireless device 101 may be improved in an adverse condition (e.g., reduced network bandwidth, reduced network coverage, low network signal strength, low battery power, high network data traffic, small display size, etc.) by modifying operation of mobile application 209 based on information regarding past usage of mobile application 209 on wireless device 101 (also referred to as past usage information) and/or based on contextual information (e.g., available network bandwidth, available battery power, display size, etc.). For example, in the event of an adverse condition, processor 205 running mobile application 209 may be provided with a probability density score (based on the past usage information) that is used to identify more/less important elements of a page before the page is rendered and/or before navigation of the page occurs. Processor 205 running mobile application 209 may thus use the past usage information to select page elements of a page to be rendered and to render the page with the selected page elements (as opposed to rending the page with all page elements). Processor 205 may thus request data from remote server 107 for only the selected page elements, and remote server 107 may respond with data for only the selected page elements, thereby reducing the transfer of data over the network. In addition, a user's current behavior relative to the rendered page (with reduced elements) may be used to update the past usage information for mobile application 209.

In CA's App Experience Analytics (AXA) product, data carrier information for a wireless device may be captured. Past usage information may be captured by extending AXA to capture one or more of the following attributes (some of which may already be captured):
Current speed of the network (static, dynamic nature of it);
Current battery % availability;
Current network usage (data in, data out); and/or
Anything else that has a direct and/or indirect impact on poor user experiences, if not dealt with in timely manner.
   Such data may be fed back to processor 205 running mobile application 209 (that is being monitored) via AXA's Software Development Kit SDK (where the SDK may sit inside mobile application 209). Mobile application 209 may be developed to take advantage of the runtime situation and change the responses (lighter/heavier) to provide a better/improved user experience by rendering screen sub-sections (also referred to as page elements), which are mostly used by the current user in context using the App or which are generally used by a majority of the users of that App.

According to some embodiments, before landing on a next page of mobile application 209 when wireless device 101 is experiencing an adverse condition, processor 205 (e.g., running mobile application 209) may perform analysis based on a current context (e.g., considering above attributes) and past usage information (e.g., how mobile application 209 has been used on wireless device 101, which pages and/or which elements of a page are important to the user of wireless device 101, etc.). For example, processor 205 running mobile application 209 may be provided with the past usage information (e.g., including probability density score data) that is used to determine an importance of that page and/or different elements of that page (e.g., areas of that page). Based on the past usage information, processor 205 running mobile application 209 may modify its runtime behavior by employing dynamic data throttling to provide an improved user experience at wireless device 101.

According to some embodiments, processor 205 running mobile application 209 may only request (e.g., fetch) data for more important page elements of the page, with other (omitted) page elements of the page being referred to as on-demand page elements of the page (which may be populated on-demand after an initial rendering of the page). Processor 205 may thus render the page including the selected page elements without rendering on-demand page elements, and a mechanism may be provided for the user to select one or more on-demand page elements to be rendered after the initial rendering.

For example, processor 205 may initially render the page with a subset of page elements of the page and with a graphical user interface (GUI) button (e.g., referred to as an on-demand button), and the user can provide user input to request presentation of on-demand page elements by selecting the button (e.g., touching the GUI button on the display, using a pointer device such as a touch pad or mouse to “click” on the GUI button, etc.). According to some other embodiments, processor 205 may initially render the page with the subset of page elements of the page, and the user can provide user input to request presentation of on-demand page elements by scrolling to the bottom of the page. Responsive to user input to request presentation of on-demand page elements, processor 205 can transmit a request (through transceiver 201) to remote server 107 to request data for the on-demand page elements, remote server 107 can transmit data for the requested on-demand page elements, processor 205 can receive the data for the requested on-demand page elements (through transceiver 201), and processor 205 can render the page including the page elements from the initial rendering and the requested on-demand page elements using the data received for the on-demand page elements. Processor 205 may update the past usage information responsive to the user input to request the on-demand page elements, and/or processor 205 may update the past usage information responsive to subsequent user selection of a particular on-demand page elements after rendering the on-demand page elements. If an on-demand page element is not selected by the user after having been rendered, past usage information for this on-demand element may remain unchanged, and this on-demand page element may remain as an on-demand page element for a later rendering of the page. If an on-demand page element is selected by the user after having been rendered, past usage information for this on-demand element may be updated so that in a later rendering of the page it will be provided in the initial rendering (e.g., the page element is no longer treated as an on-demand element).

According to some embodiments, a low battery condition of wireless device 101 may be considered as an adverse condition. In such a low battery condition, processor 205 may improve operation of mobile application 209 by reducing power consumption to increase an amount of time that wireless device 101 may continue operating before recharging. More particularly, by considering a low battery condition as an adverse condition, processor 205 may request only a subset of page elements for a page and thus receive data for only the subset of elements for the page (without receiving data for on-demand page elements) thereby reducing power required to render the page and extending a time that wireless device 101 may continue operating without recharging.

According to some embodiments, a low network data speed (of a radio access network including base station 103 and/or a local/wide area network 105 such as the Internet) may be considered as an adverse condition. In such a low data speed condition, processor 205 may improve operation of mobile application 209 to reduce a time required to render a page by reducing a volume of data transfer required to render the page. More particularly, by considering a low network data speed as an adverse condition, processor 205 may request only a subset of page elements for a page and thus receive data for only the subset of elements for the page (without receiving data for on-demand page elements) thereby reducing a time required to render the page and reduce a delay experienced by the user. Stated in other words, a time required to render the page may be reduced by reducing data input/output requirements for data transmitted/received over the network. Such low network data speed may occur due to a high volume of network data traffic, a low installed network capacity, low signal strength, etc.

According to some embodiments of inventive concepts, an improved user experience may be provided by considering the past usage information for the user using mobile application 209 and by considering a current context in which mobile application 209 is being used (e.g., battery % availability, network data in/out requirement, etc.).

Operations of wireless device 101 will now be discussed with reference to the flow chart of FIG. 3 according to some embodiments of inventive concepts. For example, wireless device 101 may be implemented using the structure of FIG. 2 with modules stored in memory 207 so that the modules provide instructions so that when the instructions of a module are executed by processor 205, processor 205 performs respective operations. Processor 205 of wireless device 101 may thus transmit and/or receive communications to/from one or more base stations 103 of a wireless communication network through transceiver 201.

At block 301, past usage information relating to past usage of mobile application 209 may be provided. Such past usage information may be saved locally on memory 207 and/or remotely at remote server 107. The past usage information may thus be provided to processor 205 from memory 207 and/or received from remote server 107 over network 105 and base station 103 through transceiver 201.

At block 303, processor 205 may accept user input to render a page of mobile application 209, and the user input may be accepted using touch sensitive display 203. For example, the user may initiate launching mobile application 209 by selecting (e.g., touching) a graphical user interface (GUI) icon provided on touch sensitive display 203, in which case rendering of a home/initial page of mobile application 209 may be requested. According to some other embodiments, mobile application 209 may have been previously launched and the user may select an item of a previously rendered page of mobile application 209 at block 303 to request rendering of a subsequent page of mobile application 209.

At block 305, processor 205 may determine whether wireless device 101 is operating in an adverse condition. An adverse condition, for example, may be a low battery power condition and/or a low network data rate condition.

Responsive to processor 205 determining that wireless device 101 is operating in an adverse condition at block 305, processor 205 may proceed with operations to reduce page elements to be rendered for the page and thereby reduce traffic needed to render the page. For example, the page may include a plurality of page elements, and in an adverse condition, processor may render a first subset of the plurality of page elements on display 203 based on the past usage information while omitting a second subset of the plurality of page elements based on the past usage information.

At block 307, processor 205 may select the first subset of the plurality of page elements of the page based on the past usage information. The past usage information may include a respective probability score for each of the plurality of page elements of the page, and selecting the first subset of page elements may include selecting the first subset based on respective probability scores for page elements of the first subset indicating probabilities of usage above a threshold and/or based on respective probability scores of page elements of the second subset indicating probabilities of usage below a threshold. Page elements that have been selected during past usage may be assigned probability scores indicating higher probabilities of usage, and pages elements that have not been selected during past usage may be assigned probability scores indicating lower probabilities of usage.

At block 309, processor 205 may transmit a request through transceiver 201 to remote server 107 for the first subset of the plurality of page elements responsive to selecting the first subset (without requesting the second subset of page elements). At block 311, processor 205 may receive data for the first subset of page elements from remote server 107 through transceiver 201 (without receiving data for the second subset of page elements).

At block 313, processor 205 may use the data received for the first subset of page elements to render the page of mobile application 209 on display 203 including the first subset of page elements without rendering (i.e., omitting) the second subset of page elements of the page. Processor 205 may thus omit the second subset of page elements when rendering the page responsive to determining that wireless device 101 is operating in an adverse condition.

Having rendered the page without the second subset of page elements at block 313, processor 205 may accept user input (e.g., through touch sensitive display 203) to display more page elements of the page at block 315. For example, processor 205 may accept user input to display more page elements based on the user scrolling to a bottom of the page. According to some other embodiments, the page may be rendered at block 313 with a graphical user interface button, and processor 205 may accept user input to display more page elements based on accepting user input to select the graphical user interface button.

Responsive to accepting user input to display more page elements at block 313, processor 205 may render the page on display 203 including the first and second subsets of the plurality of page elements at block 317. While not separately shown if FIG. 3 for the sake of conciseness, rendering the page at block 317 may include: processor 205 transmitting a request through transceiver 201 to remote server 107 for the second subset of the plurality of page elements responsive to accepting the user input to display more page elements; processor 205 receiving data for the second subset of the plurality of page elements from remote server 107 through transceiver 201; and processor 205 rendering the page at block 313 using the data for the second subset received from remote server 107. At block 319, processor 205 may update the past usage information for the page responsive to accepting the user input to display more page elements of the page.

At block 321, processor 205 may accept user input (e.g., through touch sensitive display 203) to select a page element of the page as rendered at block 313 or as rendered at block 317. Responsive to accepting such input at block 321, processor 205 may render a new page on display 203 at block 323 corresponding to the selected page element. At block 325, processor 205 may update the past usage information for the page responsive to selecting the page element. In particular, the past usage information relating to the selected page element may be updated so that in a future rendering of the page corresponding to the selected page element is more likely to be selected at block 309 and/or rendered at block 313. By way of example, processor 205 at block 317 may render the page including the first and second subsets of page elements at block 317, and at block 321, processor may accept user input to select a page element from the second subset. Responsive to accepting the user input to select the page element from the second subset, processor 205 may render the new page corresponding to the page element of the second subset at block 323 and update the past usage information for the page element of the second subset. Accordingly, the updated past usage information for the selected page element of the second subset may result in the selected page element of the second subset being included in a first subset of page elements for future selection of page elements for the page at block 307 and renderings of the page at block 313.

As discussed above, processor 205 may accept user input to render the page of mobile application 209 at block 303, and the user input may be accepted using touch sensitive display 203. If processor 205 determines that wireless device 101 is not operating in an adverse condition at block 305, processor 205 may transmit at block 331 a request through transceiver 201 to remote server 107 for the first and second subsets of the plurality of page elements. At block 333, processor 205 may receive data for the first and second subsets of the plurality of page elements from remote server 107. At block 335, processor 205 may render the first and second subsets of the plurality of page elements of the page of mobile application 209 on display 203 using the data received at block 333.

At block 336, processor 205 may accept user input (e.g., through touch sensitive display 203) to select a page element of the page as rendered at block 335. Responsive to accepting such input at block 336, processor 205 may render a new page on display 203 at block 339 corresponding to the selected page element. At block 341, processor 205 may update the past usage information for the page responsive to selecting the page element.

Various operations of FIG. 3 may be optional with respect to some embodiments. For example, operations of blocks 303, 305, 307, 309, 311, 315, 317, 319, 321, 323, 325, 331, 333, 335, 336, 339, and 341 may be optional.

Further Definitions and Embodiments are discussed below.

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a tangible computer readable storage medium. A tangible computer readable storage medium may be, for example, but not limited to, an electronic, magnetic, optical, electromagnetic, or semiconductor system, apparatus, or device, or any suitable combination of the foregoing. More specific examples (a non-exhaustive list) of the tangible computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus, and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” or “/” includes any and all combinations of one or more of the associated listed items.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method of operating a wireless device, the method comprising:
providing past usage information relating to past usage of a mobile application on the wireless device; and
rendering a page of the mobile application on a display of the wireless device based on the past usage information relating to the past usage of the mobile application on the wireless device, wherein the page includes a plurality of page elements, and wherein rendering the page includes rendering a first subset of the plurality of page elements on the display based on the past usage information and omitting a second subset of the plurality of page elements based on the past usage information.

2. The method of claim 1 further comprising:
accepting user input to render the page of the mobile application;
wherein rendering the page comprises rendering the first subset of the plurality of page elements on the display and omitting a second subset of the plurality of page elements responsive to accepting the user input and responsive to determining that the wireless device is operating in an adverse condition.

3. The method of claim 2, wherein the adverse condition comprises at least one of a low battery power condition and/or a low network data rate condition.

4. The method of claim 2, wherein the user input to render the page is first user input to render the page, the method further comprising:
accepting second user input to render the page of the mobile application; and
rendering the first and second subsets of the plurality of page elements of the page of the mobile application on the display of the wireless device responsive to accepting the second user input and responsive to determining that the wireless device is not operating in an adverse condition.

5. The method of claim 4 further comprising:
transmitting a request to the remote server for the first and second subsets of the plurality of page elements responsive to accepting the second user input and responsive to determining that the wireless device is not operating in an adverse condition; and
receiving data for the first and second subsets of the plurality of page elements from the remote server;
wherein rendering the first and second subsets of the plurality of page elements of the page comprises rendering the first and second subsets of the plurality of page elements using the data for the first and second subsets received from the remote server.

6. The method of claim 1 further comprising:
selecting the first subset of the plurality of page elements of the page based on the past usage information;
transmitting a request to a remote server for the first subset of the plurality of page elements responsive to selecting the first subset; and
receiving data for the first subset of the plurality of page elements from the remote server;
wherein rendering the page comprises rendering the first subset of the plurality of page elements using the data received from the remote server.

7. The method of claim 6, wherein the past usage information includes a respective probability score for each of the plurality of page elements of the page, and wherein selecting the first subset of page elements comprises selecting the first subset based on respective probability scores for page elements of the first subset indicating probabilities of usage above a threshold and/or based on respective probability scores of page elements of the second subset indicating probabilities of usage below a threshold.

8. The method of claim 1 further comprising:
after rendering the page, accepting user input to display more page elements of the page; and
rendering the page including the first and second subsets of the plurality of page elements on the display responsive to accepting the user input to display more page elements.

9. The method of claim 8, wherein accepting user input to display more page elements comprises accepting user input to scroll to a bottom of the page.

10. The method of claim 8, wherein rendering the page including the first subset of the plurality of the page elements while omitting the second subset comprises rendering the page with a graphical user interface button, wherein accepting user input to display more page elements comprises accepting user input to select the graphical user interface button.

11. The method of claim 8 further comprising:
updating the past usage information responsive to accepting the user input to display more page elements of the page.

12. The method of claim 8 further comprising:
transmitting a request to the remote server for the second subset of the plurality of page elements responsive to accepting the user input to display more page elements; and
receiving data for the second subset of the plurality of page elements from the remote server;
wherein rendering the page including the first and second subsets of the plurality of page elements of the page comprises rendering the first and second subsets of the plurality of page elements using the data for the second subset received from the remote server.

13. The method of claim 8 further comprising:
after rendering the page including the first and second subsets of the plurality of page elements, accepting user input to select a page element of the second subset; and
responsive to accepting the user input to select the page element of the second set, rendering a new page on the display corresponding to the page element of the second subset.

14. The method of claim 13 further comprising:
updating the past usage information responsive to accepting the user input to select the page element of the second subset.

15. A wireless device comprising:
a transceiver configured to communicate over a wireless communication network with a remote server;
a processor coupled with the transceiver, wherein the processor is configured transmit and/or receive communications through the wireless communication network using the transceiver; and
memory coupled with the processor, wherein the memory stores program instructions executable by the processor to perform operations comprising:
providing past usage information relating to past usage of a mobile application on the wireless device; and
rendering a page of the mobile application on a display of the wireless device based on the past usage information relating to the past usage of the mobile application on the wireless device, wherein the page includes a plurality of page elements, and wherein rendering the page includes rendering a first subset of the plurality of page elements on the display based on the past usage information and omitting a second subset of the plurality of page elements based on the past usage information.

16. The wireless device of claim 15, wherein the memory further stores program instructions executable by the processor to perform operations comprising:
accepting user input to render the page of the mobile application;
wherein rendering the page comprises rendering the first subset of the plurality of page elements on the display and omitting a second subset of the plurality of page elements responsive to accepting the user input and responsive to determining that the wireless device is operating in an adverse condition.

17. The wireless device of claim 15, wherein the memory further stores program instructions executable by the processor to perform operations comprising:
selecting the first subset of the plurality of page elements of the page based on the past usage information;
transmitting a request to a remote server for the first subset of the plurality of page elements responsive to selecting the first subset; and
receiving data for the first subset of the plurality of page elements from the remote server;
wherein rendering the page comprises rendering the first subset of the plurality of page elements using the data received from the remote server.

18. The wireless device of claim 15, wherein the memory further stores program instructions executable by the processor to perform operations comprising:
after rendering the page, accepting user input to display more page elements of the page;
rendering the page including the first and second subsets of the plurality of page elements on the display responsive to accepting the user input to display more page elements.

19. A computer program product, comprising:
a non-transitory computer readable storage medium comprising computer readable program code embodied in the medium that when executed by a processor of a wireless device causes the processor to perform operations comprising:
providing past usage information relating to past usage of a mobile application on the wireless device; and
rendering a page of the mobile application on a display of the wireless device based on the past usage information relating to the past usage of the mobile application on the wireless device, wherein the page includes a plurality of page elements, and wherein rendering the page includes rendering a first subset of the plurality of page elements on the display based on the past usage information and omitting a second subset of the plurality of page elements based on the past usage information.
